(19) United States
(12) Patent Application Publication
(10) Pub. No.: US 2011/0223227 A1
(43) Pub. Date: Sep. 15, 2011

(54) Method for preventing direct touch contact with a germ-laden contact surface

(76) Inventors: Robert J. Badgley, Orange, CA (US); Roger A. Roberts, Orange, CA (US); Jeanne M. Badgley, Orange, CA (US); Kristy L. Apalategui, Orange, CA (US)

(21) Appl. No.: 12/661,188

(22) Filed: Mar. 12, 2010

(51) Int. Cl. A01N 25/34

(52) U.S. Cl. 424/404

(57) ABSTRACT

A method for using a commercially-available silver-coated anti-microbial wound dressing (sold under the trademark Silverlon) as a protective guard to prevent direct touch-contact between the hand of an individual and a contact surface. The protective guard establishes a barrier to prevent the spread of germs and potentially disease-causing bacteria from the contact surface to the individual's hand. The protective guard can be carried in the individual's hand and simply moved against the contact surface. Alternatively, the protective guard an be attached to, bent around or folded over the contact surface to prevent direct touch-contact therewith.

### BACKGROUND OF THE INVENTION

1. Field of the Invention

This invention relates to a method for using a commercially-available silver-coated anti-microbial nylon wound dressing as a protective guard to prevent direct touch-contact between the hand of an individual and a contact surface containing potentially disease-causing germs and bacteria.

2. Background Art

It is known that germs, viruses and potentially health-threatening bacteria are found on a variety of touch-contact surfaces such as, for example, shopping cart handles, door handles, push plates, push buttons, exercise equipment, and the like, that are frequently touched by different individuals. Many viral infections remain untreatable, and the availability of effective anti-viral drugs and vaccines is somewhat limited. One manner to limit the transmission of viral infections and disease is for individuals to frequently wash their hands. However, some individuals choose not to regularly wash their hands, and hand washing facilities are not always readily available throughout an individual's day. Another means to reduce the spread of disease is to prevent one's hands from coming into direct touch contact with the surfaces on which such disease-causing micro-organisms lie.

Accordingly, it would be desirable to have a reliable, easy-to-attach and easy-to-replace, reusable or disposable protective guard to prevent an individual's hands from coming into direct contact with a publicly-accessible touch-contact surface and any disease-causing micro-organisms which lie thereon.

### SUMMARY OF THE INVENTION

In general terms, a method is described by which a commercially-available anti-microbial alginate medical dressing, which has heretofor been used for covering a wound to promote healing, is now used as a protective guard to create a barrier and thereby prevent direct touch-contact with a surface that contains potentially disease-causing germs and bacteria. In particular, the protective guard is a silver-coated nylon fabric that is sold commercially under the trademark Silverlon. According to the method herein disclosed, the fabric is manufactured in flat sheets that can be cut or folded to any suitable size and shape so as to cover the touch-contact surface.

The protective guard may be carried and held in an individual's hand to be laid over or pressed against a touch-contact surface to be manually engaged. The protective guard may be periodically washed and reused. In the alternative, an adhesive layer can be applied to one side of the fabric sheet which forms the protective guard. A peel-off release backing covers the adhesive layer. In this case, with the backing first removed from the sheet, the protective guard can, for example, be adhesively bonded to the push plate of a door or a push button commonly associated with an elevator. By way of further example, the protective guard may also be wrapped around the handle of exercise apparatus (e.g., a dumbbell) or one end of a sliding curtain of the kind often found in a hospital or a health care facility to separate patients' beds from one another. In this same regard, the protective guard may have a hollow cylindrical shape to slide over a door handle or the like. The protective guard can be removed from time-to-time from the touch-contact surface to which it has been applied and discarded to as to be replaced by a fresh protective guard.

### BRIEF DESCRIPTION OF THE DRAWINGS

FIG. 1 illustrates a protective guard to be used in a method for preventing direct touch-contact with a germ-laden surface, wherein the protective guard is a silver-laced, anti-microbial nylon fabric sheet;

FIG. 2 shows an adhesive layer and pull-off release backing applied to one side of the fabric sheet of FIG. 1;

FIG. 3 shows the fabric sheet of FIG. 1 after being bent over to form a protective guard having a hollow cylindrical shape;

FIG. 4 shows the fabric sheet of FIG. 1 forming a protective guard for covering the push plate of a door;

FIG. 5 shows the fabric sheet of FIG. 1 forming a protective guard wrapped around a door handle;

FIG. 6 shows the fabric sheet of FIG. 1 forming a protective guard wrapped around the handle of a dumbbell;

FIG. 7 shows the fabric sheet of FIG. 1 forming a protective guard wrapped around one end of a sliding curtain; and

FIG. 8 shows the fabric sheet of FIG. 1 forming a protective guard covering a push-button.

### DESCRIPTION OF THE PREFERRED EMBODIMENT

A method is described below for applying a disposable germ-free protective guard over a variety of contact surfaces to prevent direct touch-contact between the hand of an individual and the contact surface. In this manner, the transfer of potentially disease-causing germs and bacteria from the contact surface to the individual's hand can be avoided. According to a preferred embodiment of the method disclosed herein, the protective guard to be applied over the touch-contact surface includes an anti-microbial manuronic acid alginate wound dressing manufactured by Argentum Medical, LLC and sold commercially under the trademark Silverlon.

The aforementioned wound dressing has heretofor been used in the medical field for promoting healing by covering burns, incisions, skin grafts, donor sites, lacerations, abrasions and certain dermal ulcers. The dressing is a silver-coated non-woven nylon fabric that provides an anti-microbial cover having an active silver ingredient that is adapted to kill germs and prevent bacterial contamination of the dressing.

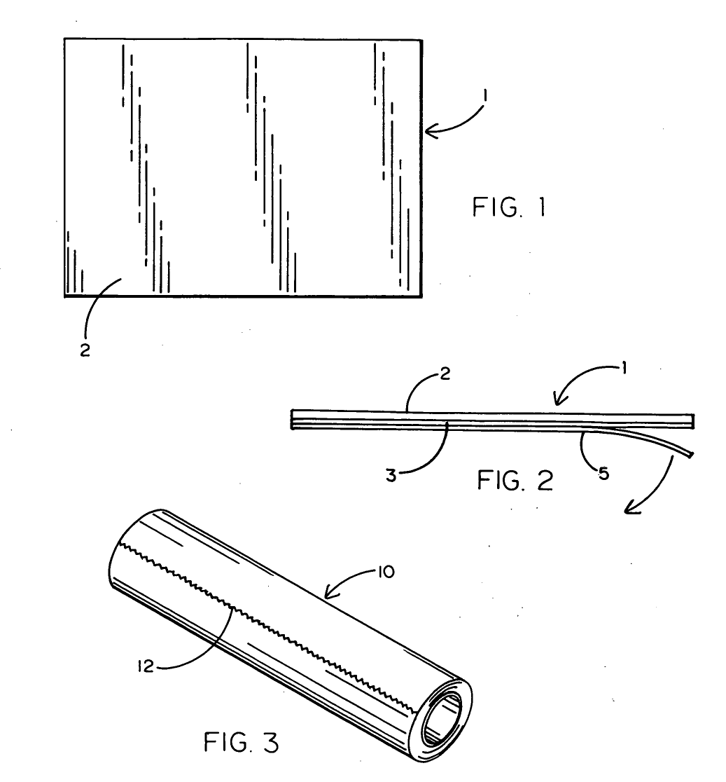

Referring to FIGS. 1 and 2 of the drawings, there is shown a protective guard 1 that is manufactured as a flat sheet 2 from the silver-coated anti-microbial alginate wound dressing material described above. Following manufacture, the sheet 2 can be cut into smaller square, rectangular, round and others shapes that correspond with the shapes and dimensions of the contact surfaces to be covered.

As best shown in FIG. 2, one side of the sheet 2 of the protective guard 1 is covered by an attachment surface 3. The attachment surface 3 enables the protective guard 1 to be held in place over and against the touch-contact surface to be engaged by the individual's hand so that the guard 1 provides a germ-resistant barrier therebetween. By way of example, the attachment surface 3 is an adhesive layer applied to the sheet 2 of protective guard 1. In this case, the adhesive layer attachment surface 3 is covered by a peel-off or quick-release (e.g., paper) backing 5 that is removed from the sheet 2 in order to expose the adhesive layer 3. The side of the protective guard 1 opposite the side to which the attachment surface 3 is applied will be grasped by the individual's hand so as to receive a gripping, pulling, pushing or similar force thereagainst. When it is desirable to remove and replace the protective guard 1, the guard is simply pulled away from the touch-contact surface so as to cause the adhesive bond between the attachment surface 3 and the touch-contact surface to be broken. The used protective guard 1 may now be discarded.

Although the attachment surface 3 of the protective guard 1 has been described above as an adhesive layer, other attachment means may be substituted therefor. For example, the attachment surface 3 may be a layer of hook-and-loop fastener material known commercially as Velcro. In this case, a complementary layer of hook-and-loop fastener material will be attached to the touch-contact surface over which the protective guard will be applied.

In some situations, the protective guard 1 may be applied on an as-needed basis to touch-contact surfaces without the use of an attachment surface. That is, the protective guard 1 may be carried in the pocket or purse of an individual and removed from time-to-time whenever it is necessary for the individual's hand to engage a germ-laden touch-contact surface. The protective guard 1 is simply held in the individual's hand and laid over or pressed against the touch-contact surface to be engaged. Since the active ingredients of the silver-coated protective guard 1 are known to kill disease-causing germs and bacteria, the guard may be returned to the individual's pocket or purse to be reused in the future with respect to another touch-contact surface. The protective guard 1 may also be periodically washed and then reused.

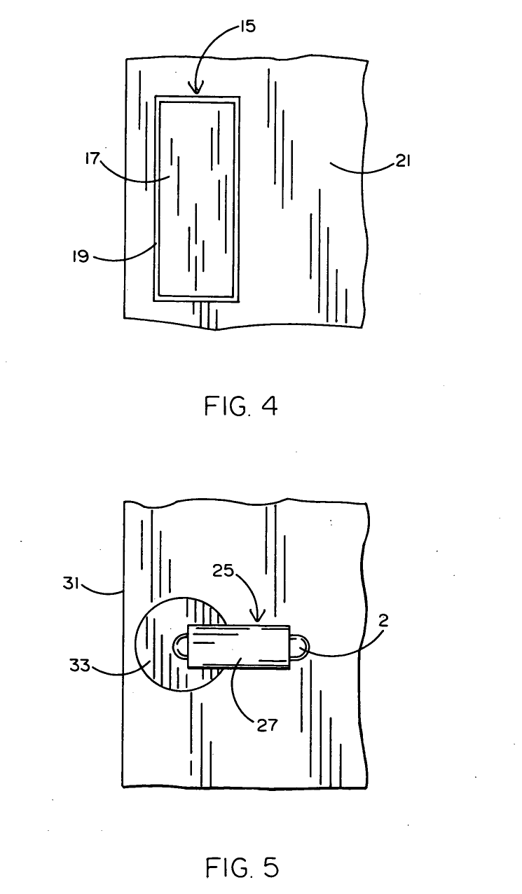

FIGS. 1 and 2 show the protective guard 1 having a flat, rectangular sheet form. FIG. 3 of the drawings shows a protective guard 10 having a hollow cylindrical shape after the ends of a rectangular piece are bent towards one another and sewn together along a stitch line 12. The cylindrical protective guard 10 is ideally suited to be removably applied to certain handles, such as those found in bathrooms. In this case, the protective guard may simply slide on and off the handle. When it is time to be replaced, the cylindrical protective guard 10 is pulled off the handle and discarded.

FIGS. 4-7 of the drawings illustrate touch-contact surfaces to which one of the flat or cylindrical protective guards 1 or 10 of FIGS. 1-3 may be applied to establish a germ-free barrier between the individual's hand and the contact surface. However, it is to be understood that the touch-contact surfaces illustrated are for purposes of example only and should not be considered as limitations of the method disclosed herein.

FIG. 4 shows a protective anti-microbial guard 15 in the form of a flat sheet 17 that is cut to size to fit the push plate 19 of a door 21 to create a germ-free barrier by which to prevent an individual's hand from making direct touch contact with the push plate 19 when a manual pushing force is applied thereto to open the door. The sheet 17 preferably has an adhesive attachment surface (not shown) similar to that designated by the reference numeral 3 in FIG. 2. The flat sheet 17 is pressed against the push plate 19 to be adhesively bonded thereto.

FIG. 5 shows a protective anti-microbial guard 25 in the form of a cylindrical sleeve 27 that slides over and along a rotatable handle 29 of a door 31. The handle 29 is of the kind having one end thereof projecting from a round door plate 33 and an opposite end bending at a right angle from the first end to be grasped in the hand of an individual. The cylindrical sleeve 27 creates a germ-free barrier by which to prevent the individual's hand from making direct touch contact with the handle 29 when a rotational force is applied to the handle to open the door 31. An attachment surface (not shown) may be applied inside the sleeve 27 to hold the sleeve against the door handle 29.

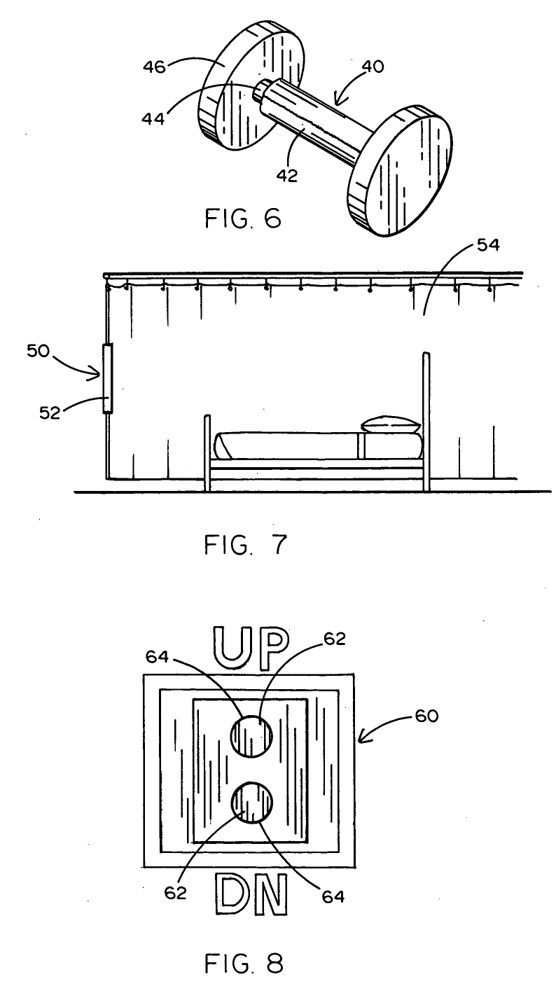

FIG. 6 shows a protective anti-microbial guard 40 in the form of a flat sheet 42 that is wrapped over itself and around the gripping bar 44 of exercise apparatus (e.g., a hand-held dumbbell 46). The flat sheet 42 may also be wrapped around the handle bar of larger equipment, such as that common to a treadmill. The sheet 42 creates a germ-free barrier by which to prevent the individual's hand from making direct touch contact with the handle 44 of the dumbbell 46 when a lifting force is applied thereto during a weightlifting exercise. An attachment surface (not shown) may be applied to the sheet 42 to hold the sheet against the gripping bar 44.

FIG. 7 shows a protective anti-microbial guard 50 in the form of a flat strip 52 that is wrapped around one end of a sliding curtain 54 of the kind used in hospitals and medical facilities to separate one patient's bed from another. The strip 52 creates a germ-free barrier by which to prevent the hand of a healthcare worker from making direct touch contact with the curtain 54 when a pulling or pushing force is applied to cause the curtain to open or close. An attachment surface (not shown) may be applied to the strip 52 to hold the strip against the curtain 54.

FIG. 8 shows a protective anti-microbial guard 60 in the form of a flat cover 62 that is laid over a push button 64 such as that to which a pushing fore is applied to call an elevator or designate a particular floor to which the elevator will travel. The push button may also be of the kind found in a hospital to which a pushing force is applied to cause a door to open. The cover 62 creates a germ-free barrier by which to prevent a finger or the hand of an individual from making direct touch contact with the push button 64 when a pushing force is applied thereto. An attachment surface (not shown) may be applied to the cover 62 to hold the cover against the push button 64.

1. A method for an individual to prevent direct touch-contact between his hand and a contact surface by which to block the spread of germs and potentially harmful bacteria from the contact surface to his hand, said method comprising the steps of:
the individual holding in his hand a silver-coated anti-microbial fabric material for dressing a wound known commercially by the trademark Silverlon; and
the individual moving his hand and said wound dressing fabric material held therein against the contact surface such that said fabric material is located between the individual's hand and the contact surface to establish a germ-free barrier therebetween.

2. A method to prevent direct touch-contact between a contact surface and the hand of an individual to block the spread of germs and potentially harmful bacteria from the contact surface to the individual's hand, said method comprising the step of covering the contact surface with a silver-coated anti-microbial fabric material for dressing a wound known commercially by the trademark Silverlon to establish a germ-free barrier between the contact surface and the individual's hand.

3. The method recited in claim 2, including the additional step of adhesively attaching said anti-microbial fabric material to the contact surface so that contact surface is covered by said material.

4. The method recited in claim 2, including the additional steps of applying an adhesive to said anti-microbial fabric material and adhesively bonding said fabric material to the contact surface so that the contact surface is covered by said material.

5. The method recited in claim 2, wherein the contact surface is a push plate of a door, said method comprising the additional step of attaching said anti-microbial fabric material over said push plate to prevent direct touch-contact between the push plate and the hand of the individual.

6. The method recited in claim 2, wherein the contact surface is a push button, said method comprising the additional step of attaching said anti-microbial fabric material over said push button to prevent direct touch-contact between the push button and the hand of the individual.

7. The method recited in claim 2, comprising the additional step of bending said anti-microbial fabric material around the contact surface.

8. The method recited in claim 2, comprising the additional step of wrapping said anti-microbial fabric material around the contact surface.

9. The method recited in claim 2, comprising the additional steps of folding said anti-microbial material to form a hollow cylinder and positioning said hollow cylinder over and around the contact surface.

10. The method recited in claim 9, wherein the touch surface is a handle, said method comprising the additional step of sliding said hollow cylinder along said handle to prevent direct touch-contact between the handle and the hand of the individual.
